(19) United States
(12) Patent Application Publication
(10) Pub. No.: US 2004/0196658 A1
(43) Pub. Date: Oct. 7, 2004

(54) Light emitting wax decoration

(75) Inventor: Chun Chung Fung, Kwun Tong (HK)

Correspondence Address: LEYDIG VOIT & MAYER, LTD, 700 THIRTEENTH ST. NW, SUITE 300, WASHINGTON, DC, 20005-3960, US

(73) Assignee: Packway Industries Limited, Kwun Tong (HK)

(21) Appl. No.: 10/406,206

(22) Filed: Apr. 4, 2003

(51) Int. Cl. F21V 35/00

(52) U.S. Cl. 362/392; 362/252; 362/276; 362/802; 362/810

(57) ABSTRACT

A light emitting decoration includes a light emitter such as a bulb, an electrical conductor attached to the light emitter, and a body formed of wax at least partially encasing the electrical conductor. A movement sensing switch is connected to a PCB that controls the light emitter.

### BACKGROUND OF THE INVENTION

The present invention relates to a light emitting wax decoration. More particularly, although not exclusively, the invention relates to electric candles having wax-encased wiring.

Wax candles with a burning wick encased in wax fuel are of course well known. Imitation candles made of plastics material and having a bulb to simulate a flame are also known. A problem with such imitation candles is that the plastics material simulating the wax is unrealistic in its appearance and weight characteristics. Also, the bulbs are not controlled to provide interesting lighting effects.

### OBJECTS OF THE INVENTION

It is an object of the present invention to overcome or substantially ameliorate at least one of the above disadvantages and/or more generally to provide a light emitting wax decoration having wax-encased wiring.

### DISCLOSURE OF THE INVENTION

There is disclosed herein a light emitting decoration comprising: a light emitter, an electrical conductor attached to the light emitter, and a body formed of wax at least partially encasing the electrical conductor.

The light emitter is typically external of the body. However, the wax might be translucent and the decoration could comprise a further light emitter internal of the body and having extending from it another electrical conductor that is at least partially encased by the wax.

If the wax is translucent, the only light emitter might be internal of the body.

Preferably, a base tray supports the body and there is a battery box in the base tray providing power to the light emitter.

Preferably, the light emitting decoration further comprises a PCB that is at least partially encased by the wax and controls power delivered via the conductor to the light emitter.

The light emitter might be a bulb or an LED.

The decoration might further include a movement sensing switch in electrical association with the light emitter.

The movement sensing switch might comprise a hollow metallic case having situated therein a metallic ball, the movement sensing switch further comprising a conductive pad with which the metallic ball can engage to close a circuit between the metallic case and the conductive pad.

There might be a further metallic ball with which the first said metallic ball can engage to close said circuit.

There might further be a first terminal extending from the metallic case and a second terminal extending from the conductive pad.

Preferably, the PCB is associated electrically with the movement sensing switch.

Preferably the PCB is associated electrically with a thermal sensor switch.

The thermal sensor switch is typically a thermister.

The tray might support a plurality of said bodies and one of said bodies further comprises a PCB that is at least partially encased by the wax and controls power delivered to a said light emitter of each body.

The PCB might provide a signal resulting in flashing of the light emitter.

### BRIEF DESCRIPTION OF THE DRAWINGS

Preferred forms of the present invention will now be described by way of example with reference to the accompanying drawings, wherein:

FIG. 1 is a schematic cross-sectional elevational view of a light emitting decoration,

FIG. 2 is a schematic cross-sectional elevational view of a slightly different light emitting decoration,

FIG. 3 is a schematic cross-sectional elevational view of another light emitting decoration,

FIG. 4 is a schematic cross-sectional elevational view of a vibration or movement sensor, and

FIG. 5 is a schematic circuit diagram for circuitry on a printed circuit board found in each of the decoration is of FIGS. 1 to 4.

### DESCRIPTION OF THE PREFERRED EMBODIMENTS

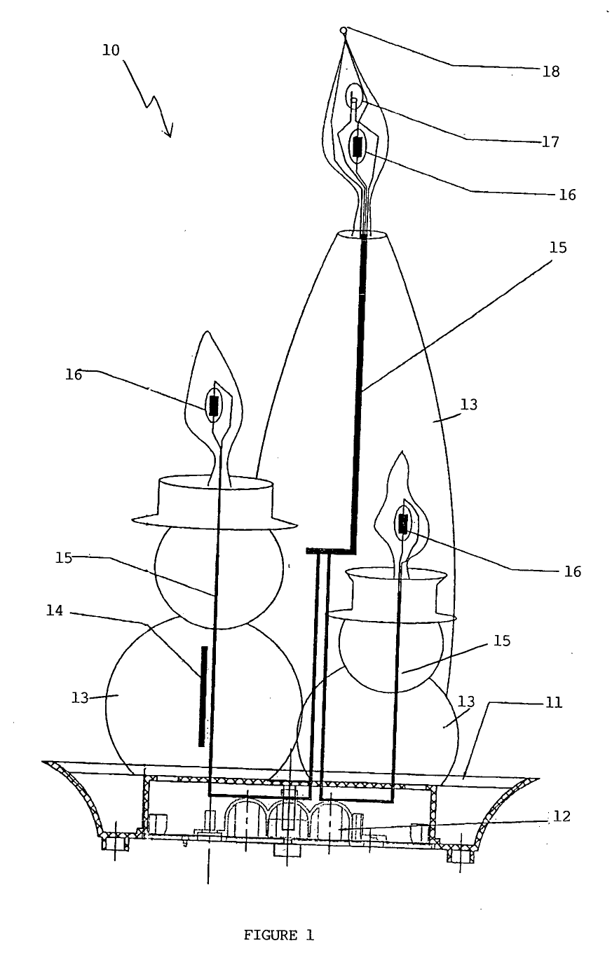

In FIG. 1 off the accompanying drawings there is depicted schematically a decoration 10. The decoration 10 includes a base tray 11 typically formed of moulded plastics material and having formed integrally therewith or attached thereto a battery box 12 for housing batteries to power the decoration's light emitters to be described later.

Supported upon the base tray 11 are several bodies 13 formed of wax. The bodies 13 might take on the shape of snowmen, candles, trees, Santa Claus or any other solid shape. Alternatively, there might be one large mass of wax, forming the overall shape of distinct bodies. That is, for example, the two snowmen shown in FIG. 1 and the candle might be joined together.

Within each wax body 13 there is an electric cord 15 delivering power to a light bulb 16 situated above the upper extremity of each body in a position that a flame might have above a candle. As an alternative to the bulbs, LEDs or other light emitters might be adopted.

There would be two or more conductors in each cord, depending upon the particular body in question. The tall body 13 in FIG. 1 has more than two conductors in its cord 15. Some of these are associated with the bulb 16 at the top of the tall body 13. Others are associated with a vibration or movement sensor 17, and others are associated with a thermal sensor switch 18.

Each cord 15 can be supported within a rigid tube supported in turn by the base tray.

The thermal sensor 18 might be a thermister or other device calibrated to trigger upon detecting heat. For example, the device might be calibrated to provide a trigger ON signal upon detecting a flame from a match or cigarette lighter.

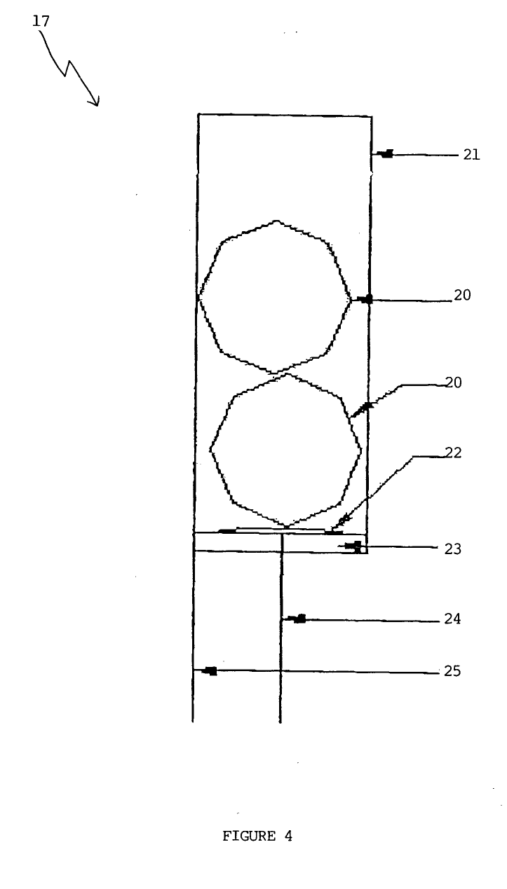

The vibration or movement sensor 17 provides a triggering signal upon movement. An example of a movement sensor 17 is shown in FIG. 4. This sensor includes a metallic encasing 21 within which there is a pair of metallic balls 20. These balls would typically be spherical. There is a contact pad 22 mounted upon a dielectric base 23 against which one of the balls 20 can engage. The metal casing 21 has a terminal 25, whereas the contact pad 23 has a terminal 24. One of these is positive and the other negative. When one of the balls is in contact with the casing, the two balls are in contact with each other and the other ball is in contact with the dielectric pad, a trigger OFF signal results. Similarly, when electrical contact between the casing and the contact pad via the balls 20 is broken, a triggering OFF signal results.

There is a printed circuit board (PCB) 14 located within one of the bodies 13. The PCB 14 receives power from batteries located within the battery box 12 and the electric cords 15 are connected to the PCB.

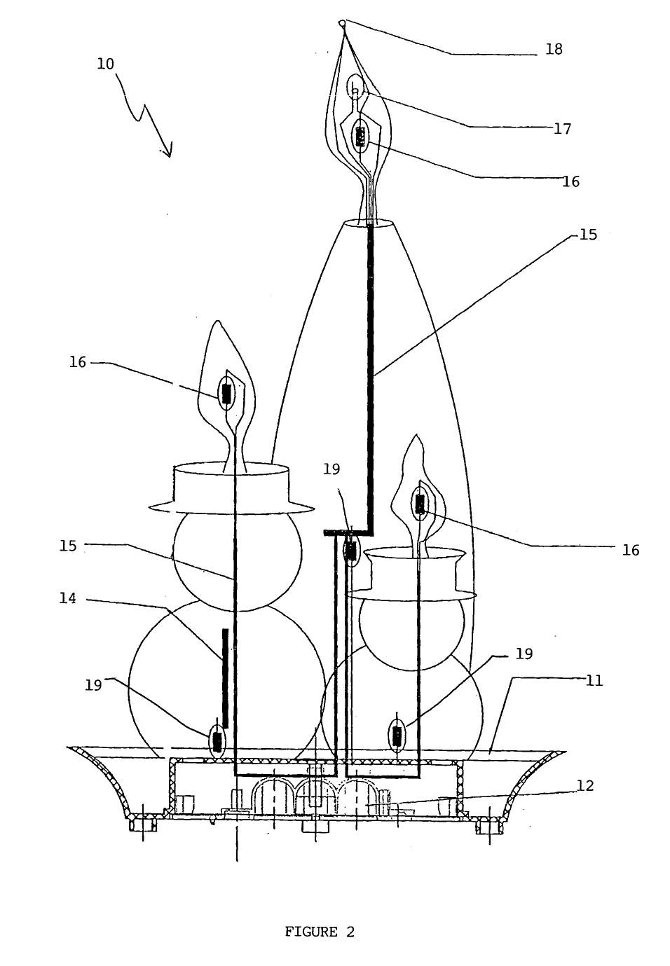

In FIG. 2, the decoration 10′ is the same as decoration 10 of FIG. 1, but includes additional light emitters 19 located internally of each body 13. In this embodiments, the wax from which each of the bodies 13 is moulded would be translucent to enable light from the emitters 19 to be seen. The light emitters 19 are also be wired to be PCB and electrical conductor's extending from the PCB to these light emitters would be encased within the wax of the respective bodies 13.

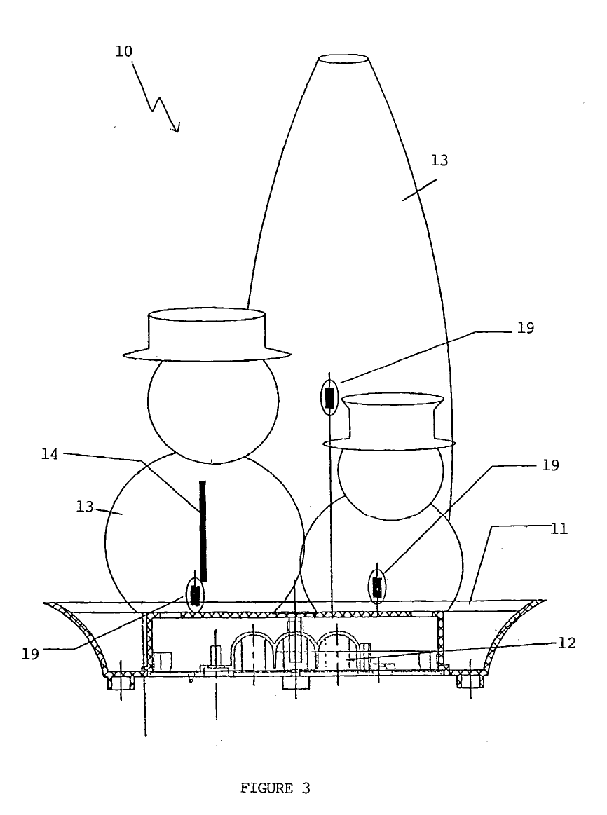

In the decoration 10″ of FIG. 3, there are no light emitters 16 externally of the respective bodies 13, but the internal light emitters 19 as shown in FIG. 2 remain. There is also know thermal sensor 18 and no vibration or movement sensor 17.

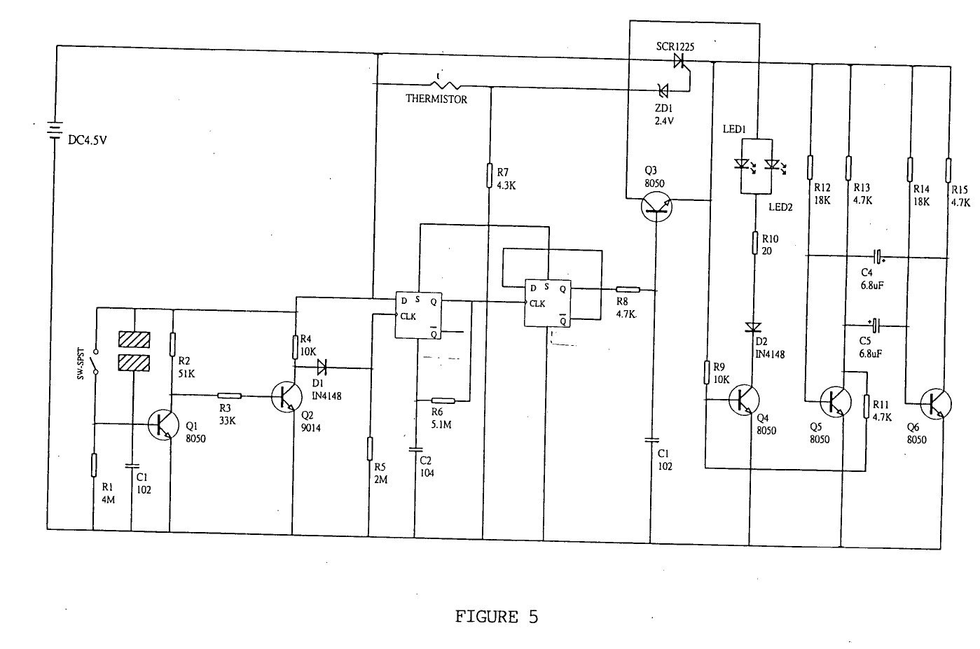

With reference to the circuit diagram shown in FIG. 5, the circuitry upon the PCB 14 would operate as follows: When A and B are short-circuited by hand, a voltage pulse signal will be generated at the base of the transistor Q1 thereby turning on Q1. At the same time, Q2 will also be turned on. This will result in a regulated output of D2 supplied to control SCR1225, thereby turning it on. A flame from a match or a cigarette lighter can be applied against or nearby the thermister t1 to reduce its resistance, thereby producing a voltage at D1 which controls SCR to turn it on. At this time, the steel ball switch is conducting. Thus, voltage is supplied from the steel ball switch via SCR to the oscillator circuit formed by Q4 and Q5. An oscillating voltage is produced at the emitter of Q4, which is supplied via R10 to the base of Q3, thereby turning Q3 on and off repeatedly. Thus, LED1 and LED2 will flash according to a certain rhythm. To turn off both LEDs, one can shake the steel ball switch (an the “flame”). This will cut voltage supplied to the anode of SCR, thereby causing the oscillator circuit to stop oscillation, hence turning off Q3 and thus turning off the LEDs.

1. A light emitting decoration comprising:
a light emitter,
an electrical conductor attached to the light emitter, and
a body formed of wax at least partially encasing the electrical conductor.

2. The light emitting decoration of claim 1 wherein the light emitter is external of the body.

3. The light emitting decoration of claim 2 wherein the wax is translucent and the decoration comprises a further light emitter internal of the body and having extending from it another electrical conductor that is at least partially encased by the wax.

4. The light emitting decoration of claim 1 wherein the wax is translucent and the light emitter is internal of the body.

5. The light emitting decoration of claim 4 comprising a further light emitter external of the body and having extending from it another electrical conductor that is at least partially encased by the wax.

6. The light emitting decoration of claim 1 further comprising a base tray supporting the body and within which there is located a battery box providing power to the light emitter.

7. The light emitting decoration of claim 1 further comprising a PCB that is at least partially encased by the wax and controls power delivered via the conductor to the light emitter.

8. The light emitting decoration of claim 1 wherein the light emitter is a bulb.

9. The light emitting decoration of claim 1 wherein the light emitter is an LED.

10. The light emitting decoration of claim 1 comprising a movement sensing switch in electrical association with the light emitter.

11. The light emitting decoration of claim 10 wherein the movement sensing switch comprises a hollow metallic case having situated therein a metallic ball, the movement sensing switch further comprising a conductive pad with which the metallic ball can engage to close a circuit between the metallic case and the conductive pad.

12. The light emitting decoration of claim 11 comprising a further metallic ball with which the first said metallic ball can engage to close said circuit.

13. The light emitting decoration of claim 11 comprising a first terminal extending from the metallic case and a second terminal extending from the conductive pad.

14. The light emitting decoration of claim 10 further comprising a PCB that is at least partially encased by the wax and controls power delivered via the conductor to the light emitter, and wherein the PCB is associated electrically with the movement sensing switch.

15. The light emitting decoration of claim 1 comprising a thermal sensor switch in electrical association with the light emitter.

16. The light emitting decoration of claim 15 further comprising a PCB that is at least partially encased by the wax and controls power delivered via the conductor to the light emitter, and wherein the PCB is associated electrically with the thermal sensor switch.

17. The light emitting decoration of claim 15 wherein the thermal sensor switch is a thermister.

18. The light emitting decoration of claim 6 wherein the tray supports a plurality of said bodies and one of said bodies further comprises a PCB that is at least partially encased by the wax and controls power delivered to a said light emitter of each body.

19. The light emitting decoration of any one of claims 7, 14 or 16 wherein the PCB provides a signal resulting in flashing of the light emitter.
